(19) United States
(12) Patent Application Publication
(10) Pub. No.: US 2012/0032383 A1
(43) Pub. Date: Feb. 9, 2012

(54) CLAMP APPARATUS

(75) Inventors: SHEN-CHUN LI, Tu-Cheng (TW); HSIEN-CHUAN LIANG, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 12/961,686

(22) Filed: Dec. 7, 2010

(30) Foreign Application Priority Data
Aug. 4, 2010 (TW) 99125834

(51) Int. Cl. B23Q 3/02

(52) U.S. Cl. 269/97

(57) ABSTRACT

A clamp apparatus includes a mounting base, a rotation actuator mounted to the mounting base, a beveled active gear driven by the rotation actuator, and at least two clamp jaws rotatably connected to the mounting base. Each clamp jaw includes a beveled driven gear engaging the beveled active gear of the clamp apparatus and a clamp body connected to the beveled driven gear. When the clamp jaws are rotated together with the beveled driven gear, the clamp bodies are moved toward or away from each other to clamp or release a workpiece, respectively.

### BACKGROUND

1. Technical Field

The present disclosure generally relates to a clamp apparatus.

2. Description of Related Art

A commonly used clamp apparatus used with a manipulator includes a first clamp arm, a second clamp arm opposite to and movable relative to the first clamp arm, and a linear actuator. Opposite ends of the first and second clamp arms define a plurality of contact surfaces corresponding to the shape and size of a clamped workpiece, respectively. Generally, the linear actuator is a cylinder moving the second clamp arm toward and away from the first clamp arm along a predetermined straight line. However, since the translation movement of the first and second clamp arms is along the straight line, the clamp apparatus has a larger dimension in this direction, thus requiring even more space for the clamping operation.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of one embodiment of a clamp apparatus, in a disengaged state.

FIG. 2 is a plan view of the clamp apparatus of FIG. 1.

FIG. 3 is an exploded, isometric view of the clamp apparatus of FIG. 1.

FIG. 4 is an isometric view of one embodiment of the clamp apparatus, in an engaged state.

FIG. 5 is a plan view of the clamp apparatus of FIG. 4.

### DETAILED DESCRIPTION

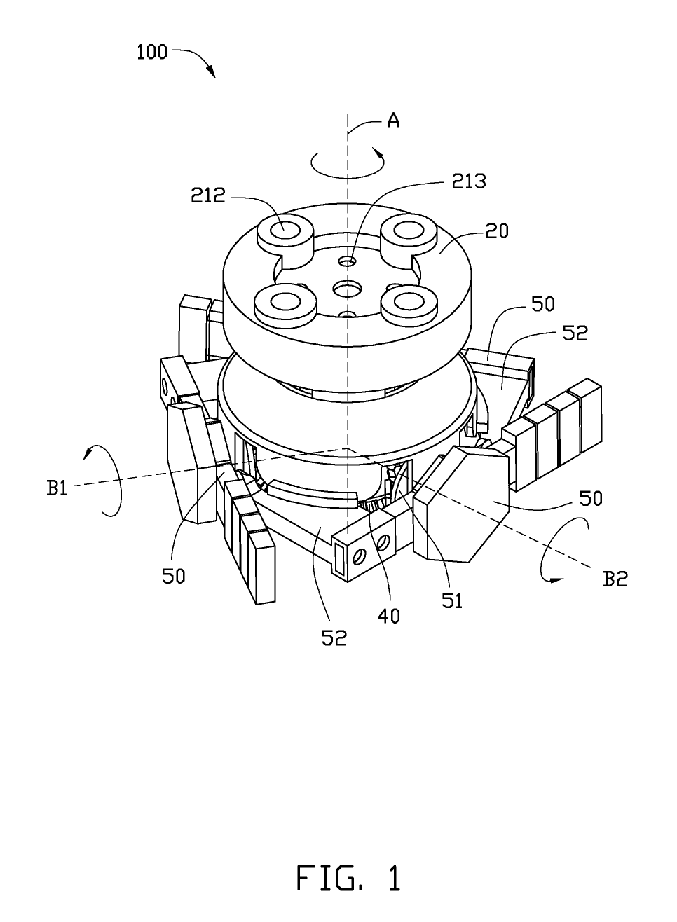

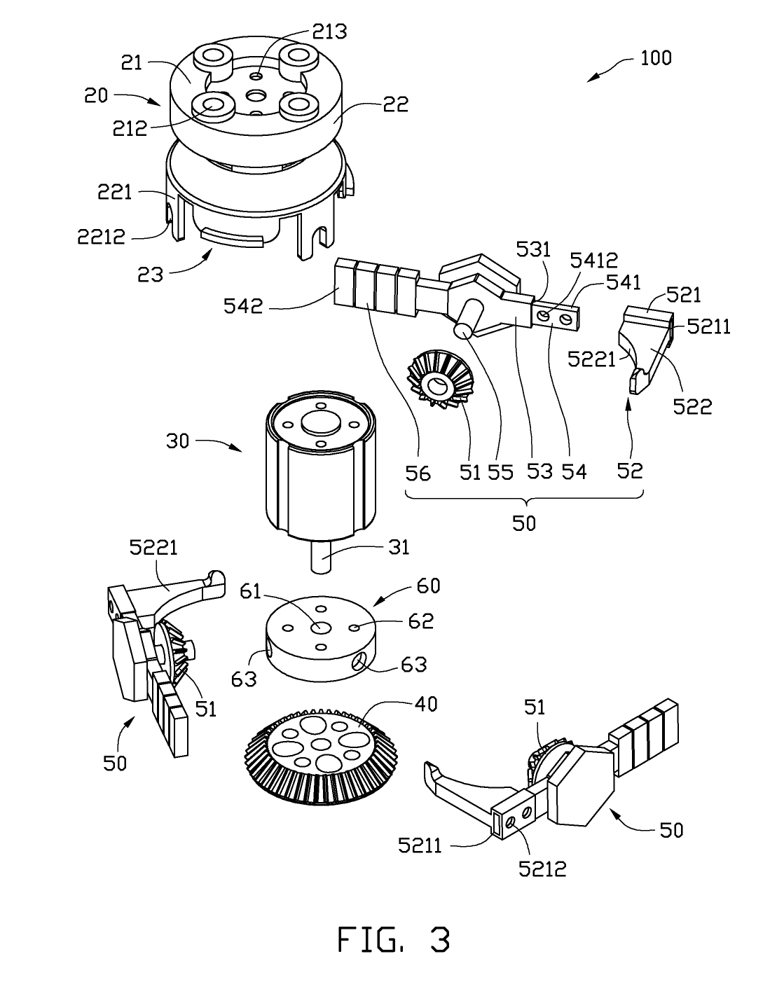

Referring to FIGS. 1 through 3, one embodiment of a clamp apparatus 100 includes a mounting base 20, a rotation actuator 30 mounted to the mounting base 20, a beveled active gear 40 driven by the rotation actuator 30, and a plurality of clamp jaws 50 arranged around the mounting base 20 and rotated by the beveled active gear 40.

Each clamp jaw 50 includes a beveled driven gear 51 engaging the beveled active gear 40 of the clamp apparatus 100, and a clamp body 52 connected to the beveled driven gear 51. When the clamp jaws 50 are rotated by the beveled active gear 40, the clamp bodies 52 engage and cooperatively clamp a workpiece.

In the illustrated embodiment, the clamp apparatus 100 includes three clamp jaws 50 evenly distributed around a circumference thereof. The beveled active gear 40 rotates about a first rotation axis A, and the three beveled driven gears 51 are rotated about three second rotation axes B1, B2, B3, respectively. The second rotation axes B1, B2, B3 are arranged in the same plane and intersect with each other to form a 120° angle therebetween (between each pair of adjacent second rotation axes, i.e. between B1 and B2, for example). The beveled active gear 40 is rotated or driven by the rotation actuator 30, whereby the beveled driven gear 51 is also rotated, and the clamp bodies 52 rotate toward or away from each other, to clamp or release a workpiece.

The mounting base 20 is substantially cylindrical and includes a top surface 21 and a sidewall 22 extending from the edge of the top surface 21. The top surface 21 and the sidewall 22 cooperatively define a receiving chamber 23. The top surface 21 defines a plurality of first mounting holes 212 and a plurality of second mounting holes 213. The first mounting holes 212 are adapted to mount the mounting base 20 to a manipulator, and the second mounting holes 213 are adapted to mount the mounting base 20 to the rotation actuator 30 so as to receive the rotation actuator 30 in the receiving chamber 23. In the illustrated embodiment, the centers of the first mounting holes 212 are arranged in a first circle and the centers of the second mounting holes 213 are arranged in a second circle having a diameter less than that of the first circle.

The rotation actuator 30 has an output shaft 31 on which the beveled active gear 40 is mounted. The rotation actuator 30 may be a stepping motor or a server motor. The rotation actuator 30 can be connected to a controller and thereby be activated.

Each clamp jaw 50 further includes a sliding sleeve 53, a connecting member 54 slidably retained in the sliding sleeve 53, a connecting shaft 55 fixed to the sliding sleeve 53 and the beveled driven gear 51, and a plurality of bob-weights 56 positioned on a distal end of the connecting member 54. The clamp body 52 is fixed to an end of the connecting member 54.

The sliding sleeve 53 defines a through hole 531 for the connecting member 54. The connecting member 54 is slidable relative to the sliding sleeve 53 and can be retained in a plurality of positions by a fixing means (not shown), so that the distance between the rotation axis of the connecting shaft 55 and the clamp body 52 is adjustable to accommodate the sizes and shapes of various workpieces.

The connecting member 54 includes a first end 541 and a second end 542 at the opposite end. The first end 541 defines a plurality of fixing holes 5412 to be detachably connected to the clamp body 52. The bob-weight 56 is secured on the second end 542. The dynamic balance of the jaws 50 can be adjusted by increasing or reducing the total amount of the weight of the bob-weights 56.

The clamp body 52 is substantially L-shaped and includes a connecting portion 521 and a contact portion 522 extending from the connecting portion 521. The connecting portion 521 defines a first connecting hole 5211 on an end surface, and a plurality of second connecting holes 5212 on a side surface of the connecting portion 521 communicated with the first connecting hole 5211. The first end 541 of the connecting member 54 is received in the first connecting hole 5211 and retained by a fastener (not shown) engageably received in the second connecting hole 5212 and the corresponding fixing hole 5412. Thus, the clamp bodies 52 are adjustable according to the shape and size of the workpieces, thus increasing the usage flexibility of the clamp apparatus 100. It should be understood that the clamp bodies 52 can be detachably connected to the connecting member 54 by any other means.

In the illustrated embodiment, the contact portion 522 has only one contact surface 5221 formed on one side thereof. In other embodiments, the contact portion 522 can be provided with two opposite contact surfaces (not shown) formed on opposite sides thereof, thus the clockwise and counterclockwise rotations of the clamp jaws 50 can be provided to accommodate for different workpieces.

The clamp apparatus 100 further includes a support member 60 positioned between the rotation actuator 30 and the beveled active gear 40. The support member 60 is disc-shaped and defines an axial through hole 61 for the output shaft 31 of the rotation actuator 30, a plurality of mounting holes 62 formed around the through hole 61 for fixing the support member 60 to the mounting base 20, and a plurality of radial shaft holes 63 for the plurality of connecting shafts 55.

The mounting base 20 forms a plurality of stopper portions 221 extending from the bottom of the sidewall 22. Each stopper portion 221 defines a cutout 2212. The stopper portion 221 is positioned between the beveled driven gear 51 and the connecting member 54, and the connecting shaft 55 is rotatably received in the cutout 2212 and engaged in the shaft hole 63, thereby rotatably connecting the clamp jaws 50 and the support member 60.

It should be understood that in alternative embodiments, the support member 60 can be omitted, wherein the mounting base 20 defines a fixing hole, the connecting shaft 55 defines a fixing groove on an end, and a clip can be engaged in the fixing groove to rotatably connect the clamp jaws 50 and the support member 60.

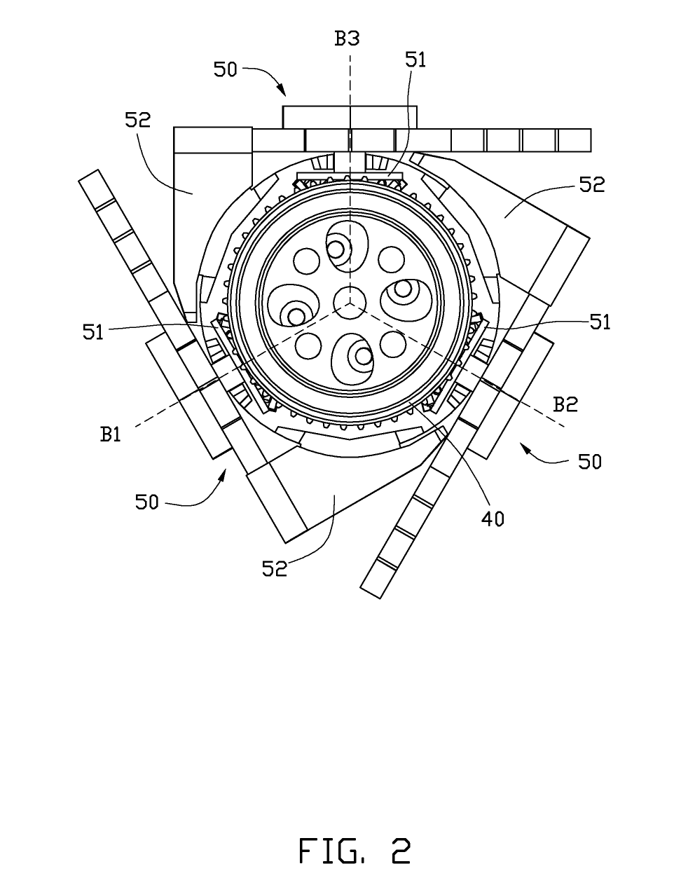

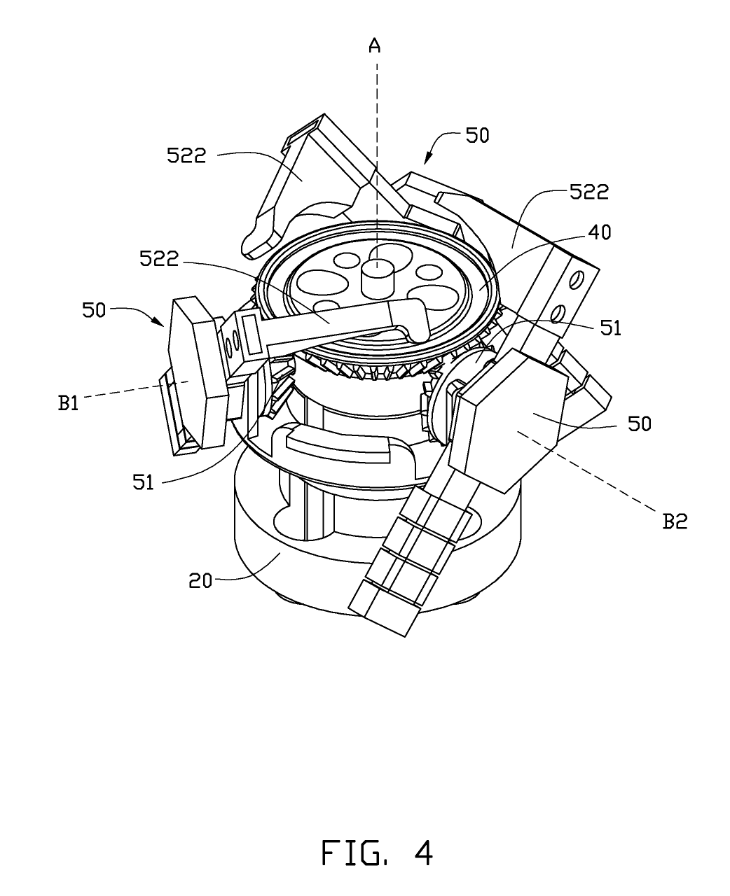

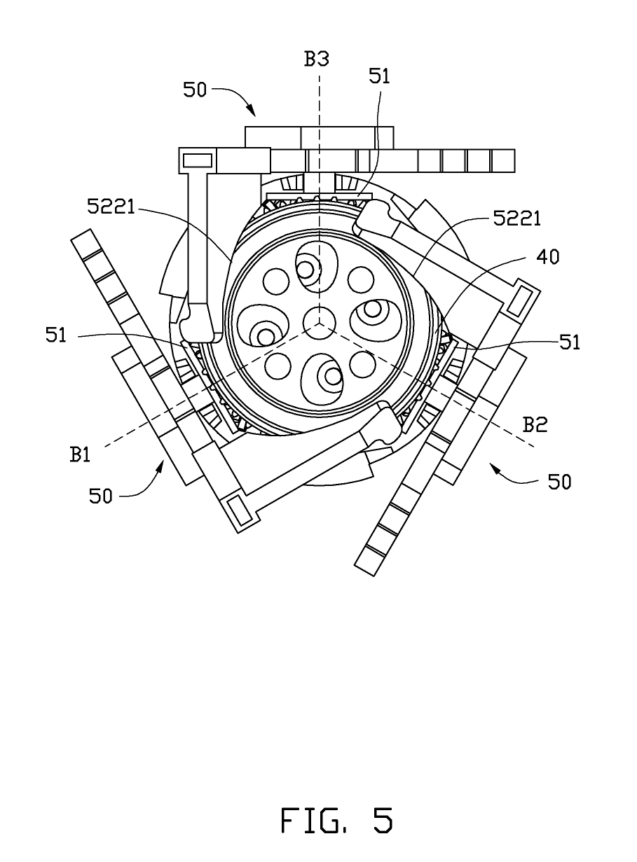

The operation of the clamp apparatus 100 is as follows. FIGS. 1 and 2 show the clamp apparatus 100 in a disengaged state, and FIGS. 4 and 5 show the clamp apparatus 100 in an engaged state. In use, the rotation actuator 30 is activated to rotate the beveled active gear 40, and the clamp jaws 50 are rotated via the engagement of the beveled active gear 40 and the beveled driven gears 51, such that the clamp bodies 52 are moved toward or away from each other, thereby switching between the engaged and disengaged states. Accordingly, when the three clamp jaws 50 are rotated about the second rotation axes B1, B2, B3 respectively, in either direction, the clamp apparatus 100 clamps and releases the workpiece, respectively. Since the clamp jaws 50 are arranged around the mounting base 20 and rotated about the second rotation axes B1, B2, B3 perpendicular to the first rotation axis A of the beveled active gear 40, the clamp apparatus 100 presents a more compact size.

It should be understood that in other embodiments, the first rotation axis A can be angled to the second rotation axes B1, B2, B3.

It is believed that the present embodiments and their advantages will be understood from the foregoing description, and it will be apparent that various changes may be made thereto without departing from the spirit and scope of the disclosure or sacrificing all of its material advantages.

1. A clamp apparatus comprising:
a mounting base;
a rotation actuator mounted to the mounting base;
a beveled active gear driven by the rotation actuator; and
at least two clamp jaws rotatably connected to the mounting base, wherein each clamp jaw comprises a beveled driven gear engaging the beveled active gear and a clamp body connected to the beveled driven gear, when the at least two clamp jaws are rotated together with the beveled driven gear, and the clamp bodies are moved toward or away from each other to clamp or release a workpiece, respectively.

2. The clamp apparatus of claim 1, wherein the beveled active gear rotates about a first rotation axis, and each clamp jaw rotates about a second rotation axis, and the first rotation axis is substantially perpendicular to the second rotation axis.

3. The clamp apparatus of claim 2, wherein the at least two clamp jaws comprises three clamp jaws, and the second rotation axes of the three clamp jaws are arranged in the same plane and intersect with each other to form a 120° angle therebetween.

4. The clamp apparatus of claim 1, wherein the beveled active gear rotates about a first rotation axis, and each clamp jaw rotates about a second rotation axis, such that the first rotation axis is angled to the second rotation axis.

5. The clamp apparatus of claim 1, wherein the at least two clamp jaws are arranged around the mounting base at the same intervals along in a circumferential direction of the mounting base.

6. The clamp apparatus of claim 1, wherein each clamp jaw further comprises a sliding sleeve, a connecting shaft formed on the sliding sleeve and secured to the beveled driven gear, a connecting member sildably retained in the sliding sleeve, and the clamp body is detachably fixed to an end of the connecting member.

7. The clamp apparatus of claim 6, wherein the sliding sleeve defines a through hole for the connecting member, and the connecting member is slidably received in the through hole and to be retained in a plurality of positions by a fixing means.

8. The clamp apparatus of claim 1, wherein the connecting member comprises a first end defining a plurality of fixing holes and a second end at the opposite end, the clamp body comprises a connecting portion and a contact portion extending from the connecting portion, the connecting portion defines a first connecting hole and a plurality of second connecting holes communicated with the first connecting hole, and the first end of the connecting member is received in the first connecting hole and retained by a fastener engaged in the corresponding second connecting hole and the fixing hole.

9. The clamp apparatus of claim 6, wherein each clamp jaw further comprises a plurality of bob-weights positioned on a distal end of the connecting member, and the dynamic balance of the clamp jaws are adjusted by adding or reducing the total amount of the weight of the plurality of bob-weights.

10. The clamp apparatus of claim 1, wherein the contact portion has one contact surface formed on one side thereof.

11. The clamp apparatus of claim 1, wherein the contact portion have two opposite contact surfaces formed on opposite sides thereof.

12. The clamp apparatus of claim 9, wherein further comprises a support member positioned between the rotation actuator and the beveled active gear, the support member defines an axial through hole for an output shaft of the rotation actuator, a plurality of mounting holes formed around the through hole for fixing the support member to the mounting base, and a plurality of radial shaft holes for the plurality of connecting shafts.

13. The clamp apparatus of claim 12, wherein the mounting base forms a plurality of stopper portion extending from the bottom of the sidewall, each stopper portion defines a cutout, the stopper portion is positioned between the beveled driven gear and the connecting member, and the connecting shaft is rotatably received in the cutout and engaged in the shaft hole, thereby rotatably connecting the clamp jaws and the support member.

14. The clamp apparatus of claim 10, wherein the mounting base defines a fixing hole, the connecting shaft defines a fixing groove on an end, and a clip is engaged in the fixing groove to rotatably connect the clamp jaws and the support member.

15. The clamp apparatus of claim 10, wherein the mounting base is substantially cylindrical and comprises a top surface and a sidewall extending from the edge of the top surface, the top surface and the sidewall cooperatively define a receiving chamber to receive the rotation actuator.

16. The clamp apparatus of claim 1, wherein the rotation actuator is a stepping motor.

17. The clamp apparatus of claim 1, wherein the rotation actuator is a server motor.
